(19) United States
(12) Patent Application Publication
(10) Pub. No.: US 2011/0062890 A1
(43) Pub. Date: Mar. 17, 2011

(54) DRIVE CIRCUIT

(75) Inventor: Yoshiyuki Oba, Isesaki-shi (JP)

(73) Assignees: SANYO Electric Co., Ltd, Moriguchi-shi (JP); SANYO Semiconductor Co., Ltd., Ora-gun (JP)

(21) Appl. No.: 12/862,909

(22) Filed: Aug. 25, 2010

(30) Foreign Application Priority Data
Sep. 15, 2009 (JP) 2009-212901

(51) Int. Cl. H05B 41/36; G05F 1/00

(52) U.S. Cl. 315/294; 323/272

(57) ABSTRACT

The invention is directed to testing breakdown voltage characteristics of a plurality of output transistors in a batch in a drive circuit instead of measurement using probe needles. A drive circuit includes output transistors made of high breakdown voltage P-channel type MOS transistors, switching control circuits, output terminals, diodes and a control terminal on a semiconductor die. The diodes are made of high breakdown voltage P-channel type MOS transistors in which the source and gate are connected. The anodes of the diodes are connected to the drains of the corresponding output terminals, respectively. The cathodes of the diodes are commonly connected to the control terminal through a wiring.

### CROSS-REFERENCE OF THE INVENTION

This application claims priority from Japanese Patent Application No. JP2009-212901, the content of which is incorporated herein by reference in its entirety.

### BACKGROUND OF THE INVENTION

### Field of the Invention

The invention relates to a drive circuit, in particular, to a drive circuit having an open drain type output transistor.

A drive circuit having an open drain type output transistor is conventionally known. A drive circuit of this type is used to drive a self emission element such as a vacuum fluorescent display, for example.

FIG. 4 is a diagram showing a structure of a drive circuit 10 for vacuum fluorescent displays. As shown in the figure, this drive circuit 10 includes output transistors T1 to Tm made of high breakdown voltage P-channel type MOS transistors and output terminals P1 to Pm made of metal pads on a semiconductor die 11.

A positive supply voltage VDD (+5 V) is applied to the sources of the output transistors T1 to Tm, and switching control signals C1 to Cm are applied to the gates thereof, respectively. The drains of the output transistors T1 to Tm are connected to the output terminals P1 to Pm, respectively.

The output terminals P1 to Pm are connected to the anodes of vacuum fluorescent displays VFD1 to VFDm provided outside the semiconductor die 11. A negative high voltage VPP (e.g. −80 V) is applied to the cathodes called filaments of the vacuum fluorescent displays VFD1 to VFDm.

When the output transistor Tx turns on, the voltage of the corresponding output terminal Px becomes the supply voltage VDD and a potential difference of the VDD+VPP (e.g. 85 V) occurs between the anode and cathode. Therefore, thermoelectrons emitted from the cathode of the corresponding vacuum fluorescent display VFDx flow in the anode through a phosphor disposed between the anode and cathode. By this, the vacuum fluorescent display VFDx lights.

When the output transistor Tx turns off, a potential difference does not occur between the cathode and anode of the corresponding vacuum fluorescent display VFDx and thermoelectrons do not flow in the phosphor. Therefore, the vacuum fluorescent display VFDx does not light. A high voltage of VDD+VPP is applied between the source and drain of the output transistor Tx at this time, the output transistor Tx need be a high breakdown voltage transistor against such a high voltage.

A relevant drive circuit is described in Japanese Patent Application publication No. 2001-209343.

The output transistors T1 to Tm need have a high breakdown voltage characteristic as described above, and in order to secure the characteristic a breakdown voltage test is performed when the wafer is completed. In this test, the output transistors T1 to Tm are turned off. Then a probe needle is connected to each of the output terminals P1 to Pm, a negative high voltage VPP (e.g. −80 V) is applied thereto, and a leakage current of each of the output transistors T1 to Tm is measured.

Then the wafer is cut into multiple semiconductor dies 11 by a scribing process, only the semiconductor dies 11 that pass the breakdown voltage test are selected, and an assembling process of the semiconductor dies 11 is performed.

However, when there are a large number of output terminals P1 to Pm, like several hundreds to thousands of output terminals P1 to Pm, there occurs a problem such as a shortage of probe needles of a prober, a long measurement time and so on.

### SUMMARY OF THE INVENTION

The provides a drive circuit that includes a plurality of output transistors. Each of the output transistors includes a P-channel type MOS transistor having a source configured to receive a positive voltage. The drive circuit also includes a plurality of switching control circuits controlling switching of corresponding output transistors, and a plurality of output terminals. Each of the output terminals is connected to a drain of a corresponding output transistor. The drive circuit further includes a plurality of rectifiers and a control terminal connected to cathodes of the rectifiers. Each of the rectifiers includes an anode connected to a drain of a corresponding output transistor.

### BRIEF DESCRIPTION OF THE DRAWINGS

FIG. 1 is a diagram showing a structure of a drive circuit of a first embodiment of the invention.

FIG. 2 is a diagram showing a structure of a drive circuit of a second embodiment of the invention.

FIG. 3 is a partial cross-sectional view of the drive circuit of the second embodiment of the invention.

FIG. 4 is a diagram showing a structure of a conventional drive circuit.

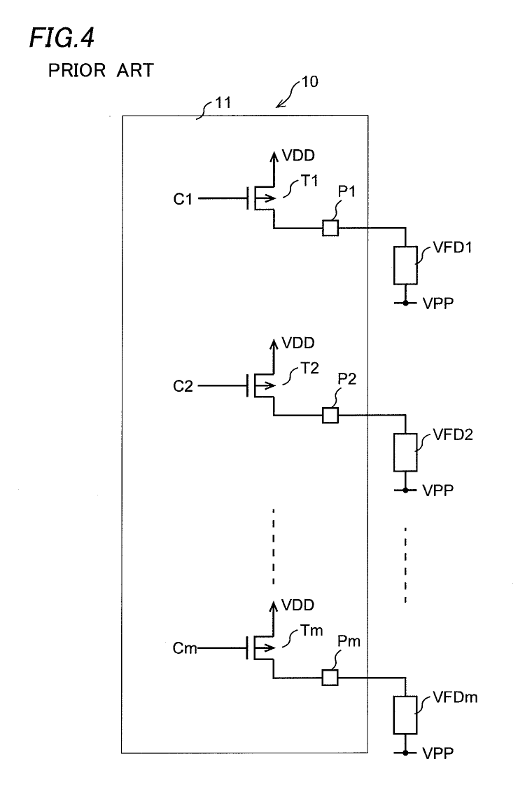

### DETAILED DESCRIPTION OF THE INVENTION

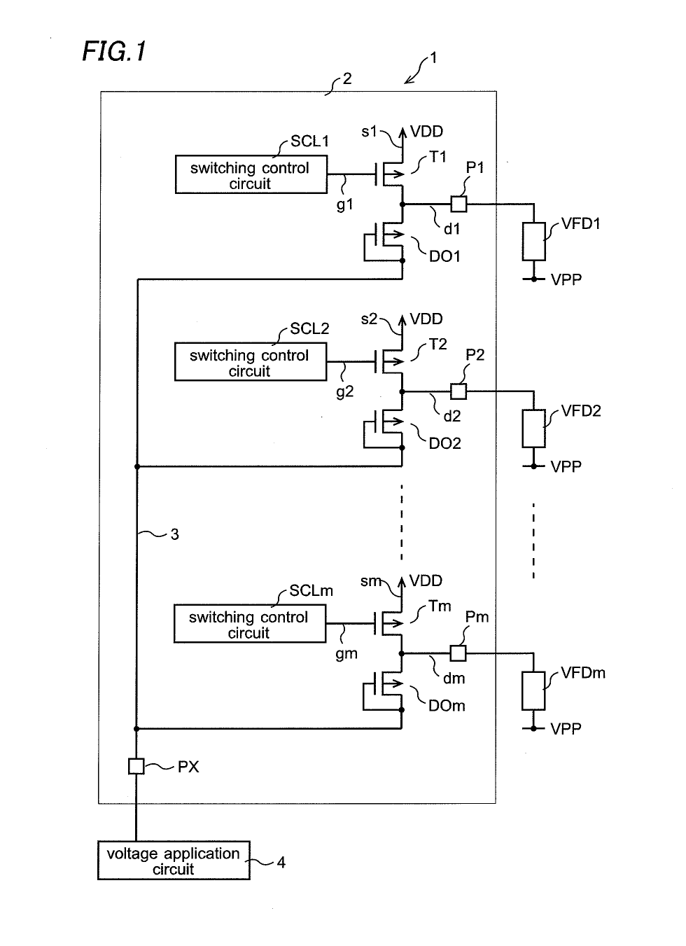

A first embodiment of the invention will be described referring to FIG. 1. As shown in the figure, a drive circuit 1 includes output transistors T1 to Tm made of high breakdown voltage P-channel type MOS transistors, switching control circuits SCL1 to SCLm, output terminals P1 to Pm made of metal pads, diodes DO1 to DOm (as an example of a “rectifier”) and a control terminal PX on a semiconductor die 2.

A positive supply voltage VDD (+5 V) is applied to the sources s1 to sm of the output transistors T1 to Tm. Switching control signals from the switching control circuits SCL1 to SCLm to which the supply voltage VDD is supplied are applied to the gates g1 to gm of the output transistors T1 to Tm respectively so as to control the on and off of the output transistors T1 to Tm. In detail, when the switching control signal of the switching control circuit SCLx is H level (=VDD), the corresponding output transistor Tx turns off, and when the switching control signal of the switching control circuit SCLx is L level (=0 V), the corresponding output transistor Tx turns on.

In this case, the switching control circuits SCL1 to SCLm are made of holding circuits that hold data (e.g. a 1 bit static type memory), and hold display data for controlling the lighting of vacuum fluorescent displays VFD1 to VFDm in this embodiment. The drains d1 to dm of the output transistors T1 to Tm are connected to the output terminals P1 to Pm, respectively.

The output terminals P1 to Pm are connected to the anodes of the vacuum fluorescent displays VFD1 to VFDm provided outside the semiconductor die 2, respectively. A negative high voltage VPP (e.g. −80 V) is applied to the cathodes of the vacuum fluorescent displays VFD1 to VFDm.

The diodes DO1 to DOm are made of high breakdown voltage P-channel type MOS transistors of which the source and gate are commonly connected. In this case, the drain serves as an anode and the source serves as a cathode. The anodes of the diodes DO1 to DOm are connected to the drains d1 to dm of the corresponding output terminals P1 to Pm, respectively. The cathodes of the diodes DO1 to DOm are commonly connected to the control terminal PX through a wiring 3.

Providing the diodes DO1 to DOm in this manner prevents a short circuit between the output terminals P1 to Pm. The reason why the diodes DO1 to DOm are made of high breakdown voltage P-channel type MOS transistors is to prevent breakdown when the negative high voltage VPP is applied to the drains d1 to dm of the output terminals P1 to Pm and the anodes of the diodes DO1 to DOm, in other words, when the diodes DO1 to DOm are reverse-biased.

The control terminal PX is connected to a voltage application circuit 4, and receives a voltage from the voltage application circuit 4. The voltage application circuit 4 is provided outside or inside the semiconductor die 2.

The drive circuit 1 of the embodiment enables testing the breakdown voltage characteristics of the output transistors T1 to Tm in a batch by using the control terminal PX. In detail, while the supply voltage VDD is supplied, all the output transistors T1 to Tm are turned off by the switching control circuits SCL1 to SCLm, and the negative high voltage VPP is applied to the control terminal PX by the voltage application circuit 4.

At this time, the diodes DO1 to DOm connected to the output transistors T1 to Tm are forward-biased, and the negative high voltage VPP is applied to the drains d1 to dm of the output transistors T1 to Tm. It is noted that this is in the case of neglecting the forward voltage of the diodes DO1 to DOm (=the threshold of the P-channel type MOS transistor). Then since the supply voltage VDD is applied to the sources s1 to sm of the output transistors T1 to Tm, a potential difference of VDD+VPP occurs between the source and drain if the output transistors T1 to Tm are normal.

Then a leakage current flowing from a supply voltage VDD application terminal (not shown) to the control terminal PX through the output transistors T1 to Tm is measured by an ammeter provided outside the semiconductor die 2.

When the measured leakage current is higher than a judgment reference value, the drive circuit 1 is judged as a defective. In this case, it is conceivable that there may be one among the output transistors T1 to Tm that is broken or deteriorated by stress by the application of the high voltage VPP, or some process error may have occurred in the wafer process or the like. When the measured leakage current is lower than the judgment reference value, the drive circuit 1 is judged as a normal.

Accordingly, the drive circuit 1 of the embodiment enables testing the breakdown voltage characteristics of the output transistors T1 to Tm in a batch without connection of probe needles to the output terminals P1 to Pm in the breakdown voltage test when the wafer is completed. This is effective when there are a large number of output terminals P1 to Pm, like several hundreds or thousands of output terminals P1 to Pm. Such a case causes a problem like a shortage of probe needles of a prober, a long measurement time and so on.

This breakdown voltage test also enables a short circuit test between the wiring 3 connected to the control terminal PX and an inner wiring adjacent to the wiring 3 in the drive circuit 1 as well as the breakdown voltage test for the output transistors T1 to Tm. For example, when there is an obstacle between the wiring 3 and the inner wiring, this is measurable since an electric current flows between these by applying the high voltage VPP to the control terminal PX.

A normal operation is as follows. In the operation, the supply voltage VDD is supplied, and the output transistors T1 to Tm, the switching control circuits SCL1 to SCLm and the voltage application circuit 4 are in operation. The control terminal PX is set at the supply voltage VDD by the voltage application circuit 4.

For example, when the output transistor T1 is in the on state, the supply voltage VDD is applied to the anode of the vacuum fluorescent display VFD1 through the output terminal P1, thermoelectrons flow in the vacuum fluorescent display VFD1, and the vacuum fluorescent display VFD1 lights. When the output transistor T2 is in the off state, the voltage of the anode of the vacuum fluorescent display VFD2 becomes VPP, thermoelectrons do not flow in the vacuum fluorescent display VFD2, and the vacuum fluorescent display VFD2 does not light.

At this time, since both the voltages of the anode and cathode of the diode DO1 connected to the output transistor T1 are VDD and the diode DO2 connected to the output transistor T2 are reverse-biased, a short circuit between the output transistors T1, T2 is prevented. In other words, by providing the diodes DO1 to DOm and setting the voltage of the control terminal PX at VDD, the output transistors T1 to Tm are electrically isolated to achieve the normal operation.

Furthermore, the control terminal PX is usable to initialize the voltages of the drains d1 to dm of the output transistors T1 to Tm when the drive circuit 1 is started or the like. For example, when the drive circuit 1 is started (when the supply voltage VDD and the high voltage VPP are supplied), the voltages of the drains d1 to dm of the output transistors T1 to Tm, i.e., the voltages of the output terminals P1 to Pm are not fixed.

Then when the drive circuit 1 is started, a potential difference may occur between the anode and cathode of the vacuum fluorescent displays VFD1 to VFDm to cause an undesirable flash of the vacuum fluorescent displays VFD1 to VFDm. In order to prevent this, the potential difference between the anode and cathode of each of the vacuum fluorescent displays VFD1 to VFDm is cancelled by applying the high voltage VPP to the control terminal PX by the voltage application circuit 4 when the drive circuit 1 is started or the like. This prevents unnecessary lighting of the vacuum fluorescent displays VFD1 to VFDm.

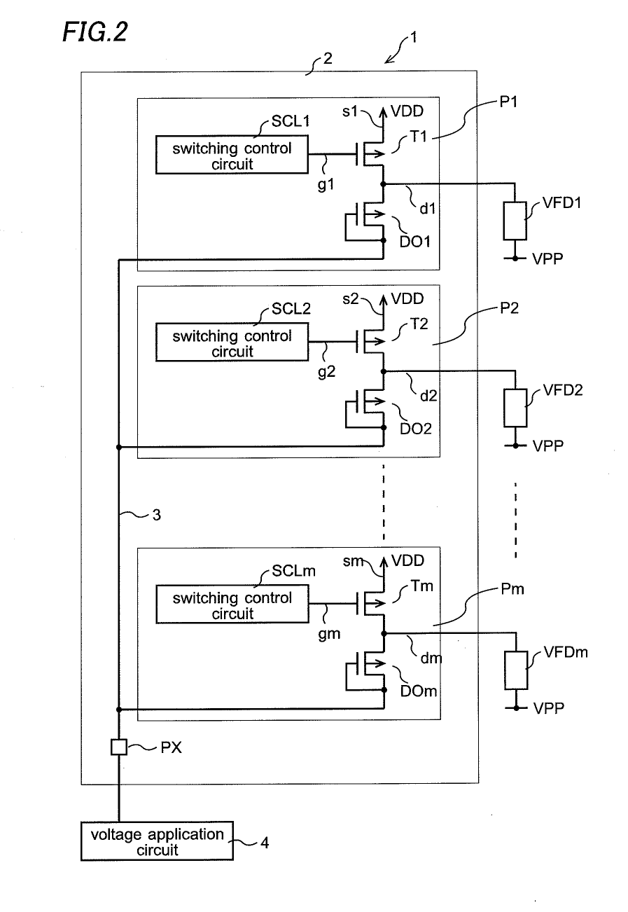

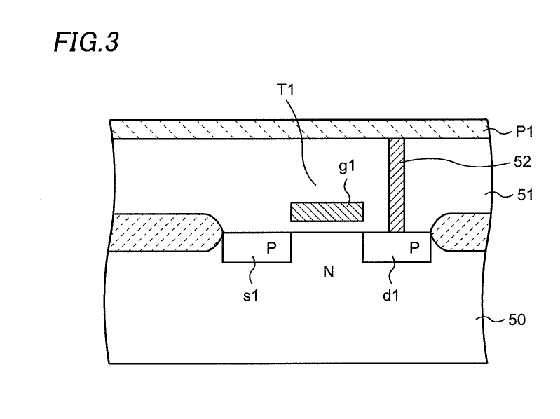

Next, a drive circuit 1 of a second embodiment of the invention will be described referring to FIGS. 2 and 3. In the embodiment, FIG. 2 shows a circuit structure of the drive circuit 1 and also a positional relation in a plan view. As shown in the figure, output transistors T1 to Tm, diodes DO1 to DOm and switching control circuits SCL1 to SCLm are disposed under the corresponding output terminals P1 to Pm.

The other structure is the same as in the first embodiment, and the drains d1 to dm of the output transistors T1 to Tm are connected to the corresponding output terminals P1 to Pm. In this case where the output transistors T1 to Tm and so on are disposed under the output terminals P1 to Pm in this manner, when a probe needle is connected to each of the output terminals P1 to Pm for measurement in a breakdown voltage test when the wafer is completed, the mechanical impact of the probe needle when connected causes the output transistors T1 to Tm and so on to be broken or the electric characteristics to be degraded.

Therefore, the method of testing the breakdown voltage characteristics of the output transistors T1 to Tm in a batch by using the control terminal PX as described above is effective particularly in this embodiment.

This case includes a case where the output transistors T1 to Tm, the diodes DO1 to DOm and the switching control circuits SCL1 to SCLm are partially or completely disposed under the corresponding output terminals P1 to Pm. For example, the invention is also effective in the case where only the output transistors T1 to Tm are disposed under the corresponding output terminals P1 to Pm, and also in the case where the output transistors T1 to Tm are partially disposed under the corresponding output terminals P1 to Pm.

FIG. 3 is a cross-sectional view of the output transistor T1. The output transistor T1 is formed on an N type semiconductor substrate 50 and covered by the output terminal P1 through an interlayer insulation film 51. The drain d1 of the output transistor T1 is connected to the output terminal P1 disposed above through a contact hole 52 formed in the interlayer insulation film 51. The output transistor T1 may be formed on an N type well formed in the front surface of a P type semiconductor substrate.

Alternatively, in order to decrease the packaging area of the display device including the drive circuit 1 and the vacuum fluorescent displays VFD1 to VFDm, the vacuum fluorescent displays VFD1 to VFDm may be disposed on the corresponding output terminals P1 to Pm.

Although the drive circuit 1 drives the vacuum fluorescent displays VFD1 to VFDm in the embodiments described above, the drive circuit 1 of the invention is not limited to this and may be used to drive other display element needing a high voltage.

The drive circuit of the invention enables testing the breakdown voltage characteristics of the plurality of output transistors T1 to Tm in a batch by using the control terminal commonly connected to the drains of the output transistors without using probe needles.

Furthermore, by applying a predetermined voltage to the control terminal, the voltages of the drains of the output transistors T1 to Tm are initialized when the drive circuit is started or the like.

Furthermore, by measuring a leakage current by applying a voltage to the control terminal, a short circuit test for an inner wiring of the drive circuit is achieved.

What is claimed is:

1. A drive circuit comprising:
a plurality of output transistors, each of the output transistors comprising a P-channel type MOS transistor comprising a source configured to receive a positive voltage;
a plurality of switching control circuits controlling switching of corresponding output transistors;
a plurality of output terminals, each of the output terminals being connected to a drain of a corresponding output transistor;
a plurality of rectifiers, each of the rectifiers comprising an anode connected to a drain of a corresponding output transistor; and
a control terminal connected to cathodes of the rectifiers.

2. The drive circuit of claim 1, wherein each of the rectifiers comprises a P-channel type MOS transistor comprising a source and a gate that are connected.

3. The drive circuit of claim 1, wherein a pair of an output transistor and a switching control circuit is disposed under a corresponding output terminal.

4. The drive circuit of claim 1, further comprising a voltage application circuit applying a negative voltage to the control terminal in a state where the output transistors are turned off by the switching control circuits.

5. The drive circuit of claim 1, further comprising a voltage application circuit initializing voltages of the drains of the output transistors by applying a predetermined voltage to the control terminal.

6. The drive circuit of claim 1, further comprising a plurality of vacuum fluorescent displays connected to corresponding output terminals.
